(19) United States
(12) Patent Application Publication
(10) Pub. No.: US 2025/0099897 A1
(43) Pub. Date: Mar. 27, 2025

(54) ADSORPTION UNIT

(71) Applicant: DELTA ELECTRONICS, INC., Taoyuan City (TW)

(72) Inventors: Chin-Chun LAI, Taoyuan City (TW); Po-Cheng KUNG, Taoyuan City (TW); Li-Chia CHEN, Taoyuan City (TW); Kun-Fu CHUANG, Taoyuan City (TW); Chia-Feng WU, Taoyuan City (TW)

(21) Appl. No.: 18/895,866

(22) Filed: Sep. 25, 2024

Related U.S. Application Data
(60) Provisional application No. 63/540,640, filed on Sep. 26, 2023.

(51) Int. Cl. B01D 53/04

(52) U.S. Cl. CPC B01D 53/0407; B01D 2253/116; B01D 2257/504; B01D 2257/80

(57) ABSTRACT

This disclosure is directed to an adsorption unit, having a frame, multiple spacer tubes and multiple adsorption granules. The frame has an inlet side and an exhaust side. The spacer tubes are arranged in the frame, and a plurality of through holes are provided on each of the spacer tubes. The adsorbed granules are arranged in the frame, and the adsorbed granules are restricted by the spacers and fixed in the frame so as to locate between the inlet side and the exhaust side. Air enters the adsorption unit from the environment through the inlet side, passes through the adsorption unit, and leaves the adsorption unit through the exhaust side. The air passes through the adsorption unit and returns to the environment so as to contact the adsorption granules to remove carbon dioxide and water.

### CROSS-REFERENCE TO RELATED APPLICATION

This patent application claims the benefit of U.S. Provisional Patent Application No. 63/540,640, filed Sep. 26, 2023, which is incorporated by reference herein.

### BACKGROUND OF THE INVENTION

### Technical Field

This disclosure is directed to a system of carbon capture, utilization and storage (CCUS), in particular, to an adsorption unit for capturing carbon dioxide from ambient air.

### Description of Related Art

Adsorption gas separation is a commonly used industrial method. In recent years, in order to achieve climate protection goals, methods for removing CO₂ (carbon dioxide) from industrial waste gases or the atmosphere, especially the latter method called direct air capture (DAC), have applied favorable energy sources and related processing infrastructure, there are many previous cases to reduce carbon dioxide emissions into the atmosphere, thereby reducing the greenhouse effect.

Carbon capture, utilization and storage (CCUS) system involves the capture of carbon dioxide, generally from large point sources such as power generation or industrial facilities that use either fossil fuels or biomass as fuel. CCUS can tackle emissions in hard-to-abate sectors, particularly heavy industries like cement, steel, or chemicals. CCUS is an enabler of least-cost low-carbon hydrogen production, which can support the decarbonization of other parts of the energy system, such as industry, trucks, and ships. CCUS can remove carbon dioxide from the air to balance emissions that are unavoidable or technically difficult to abate.

Accordingly, providing an adsorption unit that can efficiently capture carbon dioxide from ambient air is an important issue in the art.

### SUMMARY OF THE INVENTION

This disclosure is directed to an adsorption unit for capturing carbon dioxide from ambient air.

This disclosure is directed to an adsorption unit having a frame, multiple spacer tubes and multiple adsorption granules. The frame has an inlet side and an exhaust side. The spacer tubes are arranged in the frame, each of the spacer tubes having a lateral side defined with a plurality of through holes. The adsorption granules are arranged in the frame, and are restricted by the spacer tubes to be fixed in the frame and between the inlet side and the exhaust side.

In one of the exemplary embodiments, a first space is defined between the frame and the spacer tubes, and the adsorption granules are disposed in the first space.

In one of the exemplary embodiments, each of the spacer tubes has a second space defined therein, and the adsorption granules are disposed in the second spaces, respectively.

In one of the exemplary embodiments, the frame has a plurality of sealing plates, the sealing plates are annularly arranged to connect between the inlet side and the exhaust side, and each of the spacer tubes is arranged to cross the inlet side and the exhaust side.

In one of the exemplary embodiments, each of the spacer tubes has two open ends opposite to each other, and two of the open ends on each of the spacer tubes are arranged corresponding to the inlet side and the exhaust side, respectively.

In one of the exemplary embodiments, the frame has a pair of communicating plates and a plurality of sealing plates, the pair of communicating plates are arranged at the inlet side and the exhaust side, respectively. The sealing plates are arranged to surround the pair of communicating plates and connected between the pair of communicating plates, and each of the open ends on each of the spacer tubes are connected to the communicating plates, respectively, to communicate out sided of the frame.

In one of the exemplary embodiments, each of the spacer tubes is conical, and on each of the spacer tube, a narrower one of the open ends of the spacer tube is arranged corresponding to the exhaust side.

In one of the exemplary embodiments, the spacer tubes are fixed in the frame, each of the spacer tube has two ends connected to the frame, respectively.

In one of the exemplary embodiments, the spacer tubes are substantially parallel to each other and separated from each other.

In one of the exemplary embodiments, each of the spacer tubes is made of aluminum or alloy thereof.

The air enters the adsorption unit from the environment through the inlet side, then passes through the adsorption unit and exits the adsorption unit through the exhaust side. The ambient air is contacted with the adsorption granules via the through holes when passing through the adsorption unit so that the carbon dioxide and water carried therein are adsorbed by the adsorption granules. A part of the carbon dioxide and water contained in the air is removed in the adsorption unit, and then the air is exhausted from the adsorption unit through the exhaust side and returned to the environment.

According to this disclosure, the adsorption unit adsorption unit has a frame for limiting a flow direction of the airflow, and the adsorption unit further has spacer tubes arranged in the frame. The adsorption granules are arranged along the flow direction of the airflow via the spacer tubes so that the air is contacted with the adsorption granules in a longer period when passing through the adsorption unit, and carbon dioxide and water are therefore adsorbed from the air more efficiently by the adsorption granules.

### BRIEF DESCRIPTION OF THE DRAWINGS

The features of the disclosure believed to be novel are set forth with particularity in the appended claims. The disclosure itself, however, may be best understood by reference to the following detailed description of the disclosure, which describes a number of exemplary embodiments of the disclosure, taken in conjunction with the accompanying drawings, in which:

FIG. 1 is a perspective view showing an adsorption module and adsorption units thereof according to this disclosure;

FIG. 2 is an exploded view showing the adsorption unit according to the first embodiment of this disclosure;

FIG. 3 is a perspective view showing the adsorption unit according to the first embodiment of this disclosure;

FIG. 4 is a cross-sectional view of the adsorption unit crossing a passing direction of airflow according to the first embodiment of this disclosure;

FIG. 5 is a cross-sectional view of the adsorption unit along a passing direction of airflow according to the first embodiment of this disclosure;

FIG. 6 is a perspective view showing an adsorption unit according to the second embodiment of this disclosure;

FIG. 7 is a perspective view showing the adsorption unit according to the third embodiment of this disclosure;

FIG. 8 is a perspective view showing the adsorption unit according to the fourth embodiment of this disclosure;

FIG. 9 is an exploded view showing the adsorption unit according to the fifth embodiment of this disclosure;

FIG. 10 is a perspective view showing the adsorption unit according to the fifth embodiment of this disclosure; and

FIG. 11 is a cross-sectional view of the adsorption unit along a passing direction of airflow according to the fifth embodiment of this disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

Detailed descriptions and technical contents of this disclosure is described in the flowing paragraph with reference to the drawings. However, the drawings are attached only for illustration and are not intended to limit this disclosure.

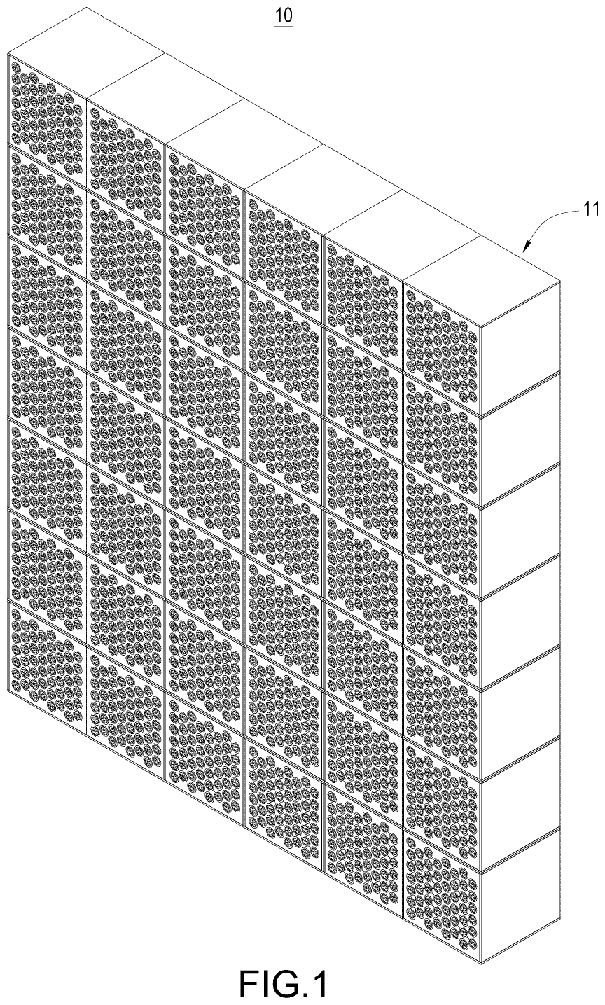

According to an adsorption unit 11 and an adsorption module 10 of this disclosure as shown in FIG. 1, in order to reduce the greenhouse effect, this disclosure provides an adsorption unit 11 with an adsorption unit for capturing carbon dioxide. Accordingly, this disclosure is directed to an adsorption unit 11 for capturing carbon dioxide from ambient air. The ambient air recited in this disclosure may be industrial waste gas or atmosphere containing carbon dioxide.

According to this disclosure, the molecular sieve is used as an adsorption material for adsorbing carbon dioxide or water. The adsorption material is a powdery adsorption material in original, and the powdery adsorption material is sintered into a granular adsorbent material applied in the adsorption unit adsorption unit 11 of this disclosure.

The molecular sieve is a solid chemical functionalized adsorbent material, which is suitable for adsorbing carbon dioxide with a concentration of approximately 400 ppm. The Molecular sieve adsorbs carbon dioxide and water at room temperature namely between 25° C. and 35° C. The adsorption efficiency decreases with a temperature increasing, and the molecular sieve stops adsorbing and begins to desorb at a temperature higher than 60° C.

The molecular sieve has at least the components of K₂O (potassium oxide), CaO (calcium oxide), Al₂O₃ (aluminum oxide), SiO₂ (silicon dioxide) and Na₂O (sodium oxide). The melting point of the molecular sieve is approximately 2230° C. The particles of the molecular sieve have a density within 0.65-0.8 g/cm³.

This disclosure provides an adsorption unit 11 having granules of the adsorption material. A plurality of adsorption units 11 are arranged in a stack and defined as an adsorption module 10. The adsorption module 10 further has a rack as a structure for supporting the stacked adsorption units 11. The adsorption module 10 is suitable for an adsorption process in a room temperature environment and a desorption process in a high temperature environment. The adsorption material can adsorb carbon dioxide and water at the same time, considering this, a plurality of adsorption modules 10 are used cooperatively to improve adsorptions of water and carbon dioxide and result in a higher concentration of carbon dioxide adsorbed in the adsorption modules 10.

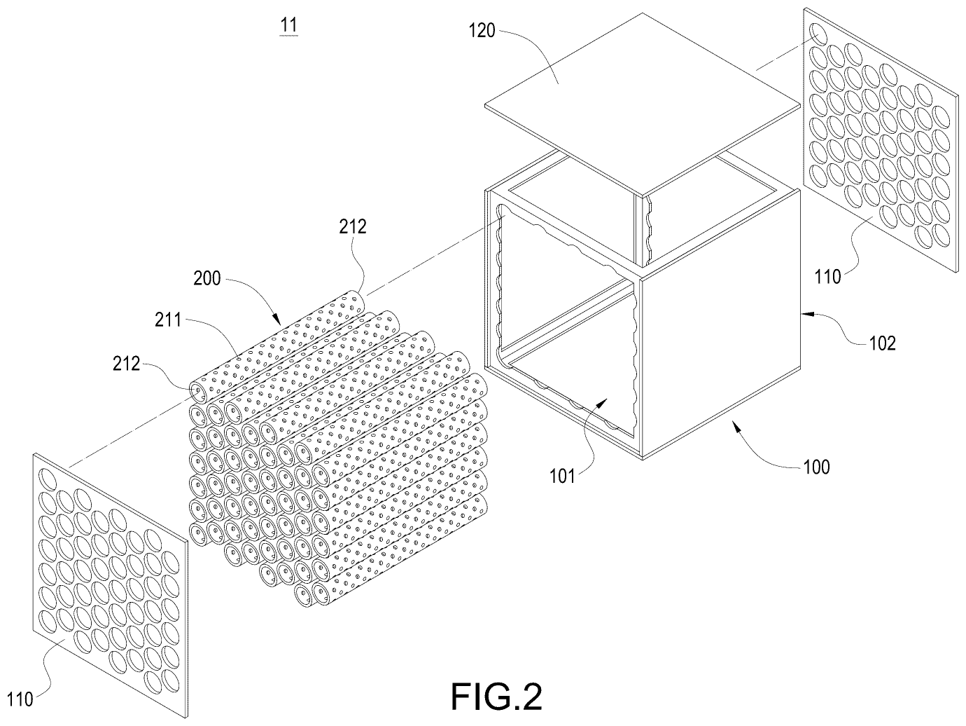

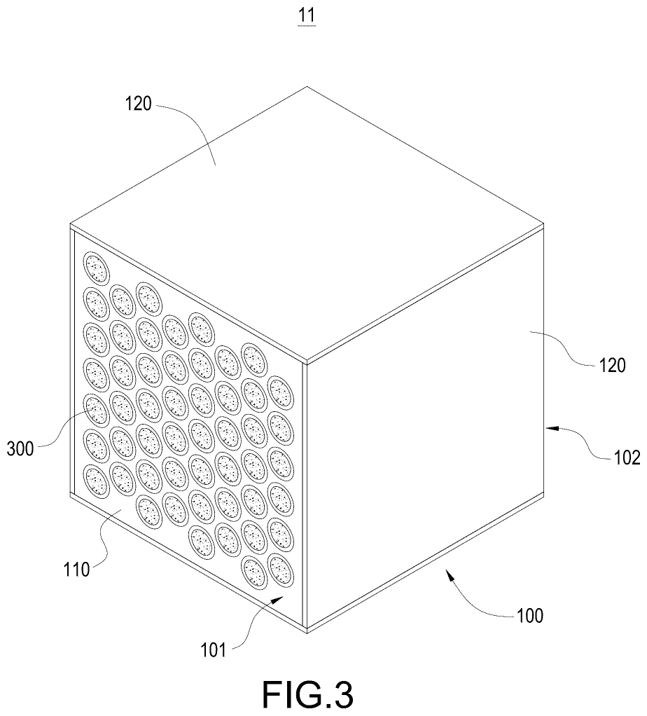

FIG. 2 is an exploded view showing the adsorption unit 11 according to the first embodiment of this disclosure, and FIG. 3 is a perspective view showing the adsorption unit 11 according to the first embodiment of this disclosure. According to the first embodiment of this disclosure as shown in FIGS. 2 and 3, an adsorption unit 11 having a frame 100, a plurality of spacer tubes 200 and a plurality of adsorption granules 300 is provided.

Referring to FIGS. 2 and 3, in this embodiment, the frame 100 has an inlet side 101 and an exhaust side 102. The inlet side 101 and the exhaust side 102 are open and opposite to each other, and rest portions of the frame 100 (other than the inlet side 101 and the exhaust side 102) are closed. Specifically, the frame 100 has a pair of communicating plates 110 and a plurality of sealing plates 120. The communicating plates 110 are defined with holes so as to be open. The pair of communicating plates 110 are arranged at the inlet side 101 and the exhaust side 102, respectively, so that the inlet side 101 and the exhaust side 102 are open, and the sealing plates 120 are arranged to surround the pair of communication plates 110. The sealing plates 120 are connected between the inlet side 101 and the exhaust side 102 to seal the rest portions of the frame 100.

Then referring to FIGS. 2 and 3, according to this embodiment, each of spacer tubes 200 is a straight tube made of aluminum or alloy thereof, but the scopes of this disclosure should not be limited to this. Each of the spacer tubes 200 has a lateral side defined with a plurality of through holes 211 allowing the air to pass. The spacer tubes 200 are arranged in the frame 100, and the spacer tubes 200 are substantially parallel to each other and separated from each other. Specifically, each of the spacer tubes 200 has two ends connected to the frame 100, respectively, so that the spacer tubes 200 are fixed to the frame 100.

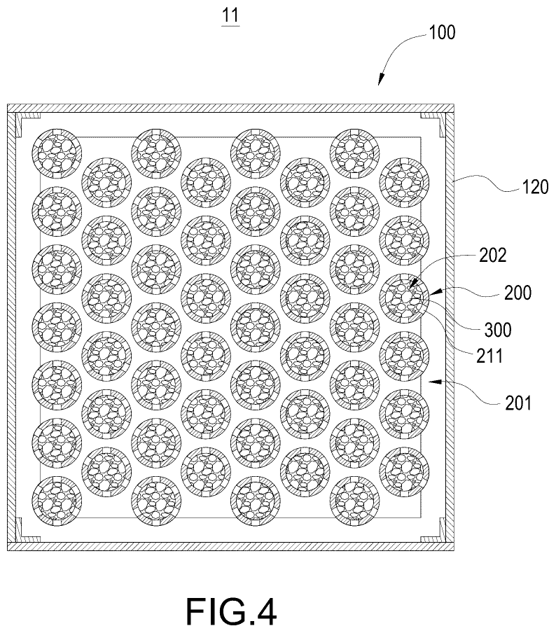

FIG. 4 is a cross-sectional view of the adsorption unit crossing a passing direction of airflow according to the first embodiment of this disclosure. Referring to FIGS. 3 and 4, in this embodiment, each of the spacer tubes 200 has two open ends 212 opposite to each other, and two of the open ends 212 on each of the spacer tubes 200 are configured corresponding to the inlet side 101 and the exhaust side 102, respectively. The open ends 212 on each of the spacer tubes 200 are connected to the communicating plates 110, respectively, so as to communicate with outside of the frame 100. A first space 201 is defined between the frame 100 and the spacer tubes 200, and each of the spacer tubes 200 is defined with a second space 202 therein.

Referring to FIGS. 3 and 4, the adsorption granules 300 are granules made of the adsorption material, and the adsorption material is molecular sieve. Each of the adsorption granules 300 is a granule larger than the through hole 211. Accordingly, the adsorption granules 300 are arranged in the frame 100 and restricted by the spacer tubes 200 to be fixed in the frame 100 between the inlet side 101 and the exhaust side 102. In this embodiment, the adsorption granules 300 are arranged in the second spaces 202.

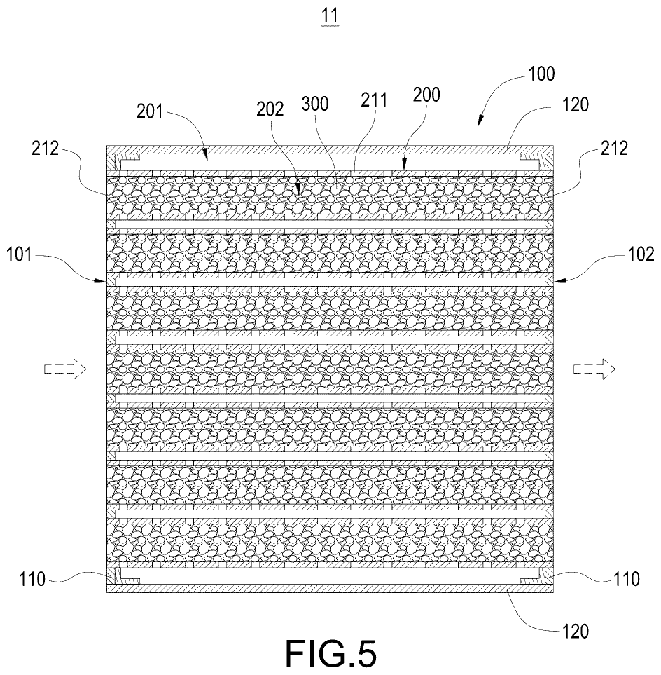

FIG. 5 is a cross-sectional view of the adsorption unit 11 along a passing direction of airflow according to the first embodiment of this disclosure. Referring to FIG. 5, the air enters the adsorption unit 11 from the environment through the inlet side 101, then passes through the adsorption unit 11 and exits the adsorption unit 11 through the exhaust side 102. The open ends 212 are configured to restrict the adsorption granules 300 in the spacer tube 200. The ambient air is contacted with the adsorption granules 300 via the through holes 211 when passing through the adsorption unit 11, so that the carbon dioxide and water carried therein are adsorbed by the adsorption granules 300. A part of the carbon dioxide and water contained in the air is removed in the adsorption unit 11, and then the air is exhausted from the adsorption unit 11 through the exhaust side 102 and returned to the environment.

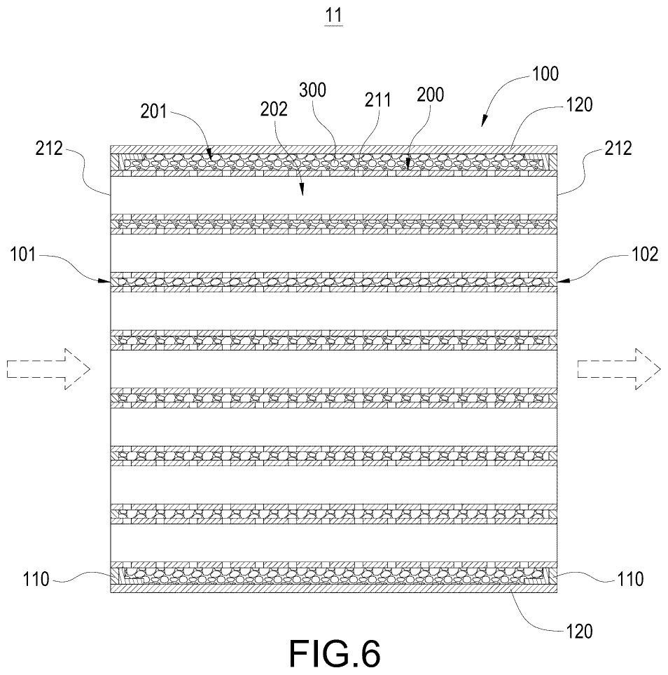

Referring to an adsorption unit 11 according to the second embodiment of this disclosure as shown in a schematic view of FIG. 6, an adsorption unit 11 having a frame 100, a plurality of spacer tubes 200, and a plurality of adsorption granules 300 is provided in the second embodiment.

Also referring to FIG. 2, in this embodiment, the frame 100 and the spacer tubes 200 have structures the same as that of the first embodiment. In other words, the frame 100 has an inlet side 101 and an exhaust side 102, the inlet side 101 and the exhaust side 102 are open, and the rest portions of the frame 100 are closed. Specifically, the frame 100 has a pair of communicating plates 110 and a plurality of sealing plates 120. The communicating plates 110 are defined with holes so as to be open. The pair of communicating plates 110 are arranged at the inlet side 101 and the exhaust side 102, respectively, so that the inlet side 101 and the exhaust side 102 are open, and the sealing plates 120 are arranged to surround the pair of communication plates 110. The sealing plates 120 are connected between the inlet side 101 and the exhaust side 102 to seal the rest portions of the frame 100.

In this embodiment, each of the spacer tubes 200 is a straight tube made of aluminum or alloy thereof, but the scopes of this disclosure should not be limited to this. Each of the spacer tubes 200 has a lateral side defined with a plurality of through holes 211 allowing the air to pass. The spacer tubes 200 are arranged in the frame 100 to be substantially parallel to each other and separated from each other. Specifically, each of the spacer tubes 200 has two ends connected to the frame 100, respectively, thereby fixing the spacer tubes 200 in the frame 100.

In this embodiment, each of the spacer tubes 200 has two open ends 212 opposite to each other, and two of the open ends 212 on each of the spacer tubes 200 are arranged corresponding to the inlet side 101 and the exhaust side 102, respectively. The open ends 212 on each of the spacer tubes 200 are connected to the communicating plates 110, respectively, so as to communicate with outside of the frame 100. A first space 201 is defined between the frame 100 and the spacer tubes 200, and each of the spacer tubes 200 is defined with a second space 202 therein.

Referring to FIG. 6, the adsorption granules 300 are granules made of the adsorption material, and the adsorption material is molecular sieve. Each of the adsorption granules 300 is a granule larger than the through hole 211. Accordingly, the adsorption granules 300 are arranged in the frame 100 and restricted by the spacer tubes 200 to be fixed in the frame 100 between the inlet side 101 and the exhaust side 102. According to this embodiment, the adsorption granules 300 are disposed in the first space 201, and the second spaces 202 are defined as a flow channel communicated between the inlet side 101 and the exhaust side 102.

Accordingly, air enters the adsorption unit 11 from the environment through the inlet side 101 and be discharged from the adsorption unit 11 through the exhaust side 102 after passing through the flow channel. The ambient air is contacted with the adsorption granules 300 via the through holes 211 when passing through the flow channel so that carbon dioxide and water carried in the ambient air are adsorbed by the adsorption granules 300. A portion of carbon dioxide and water is removed from the air in the flow channel, and then the air is discharged from the adsorption unit 11 through the exhaust side 102 and returned to the environment.

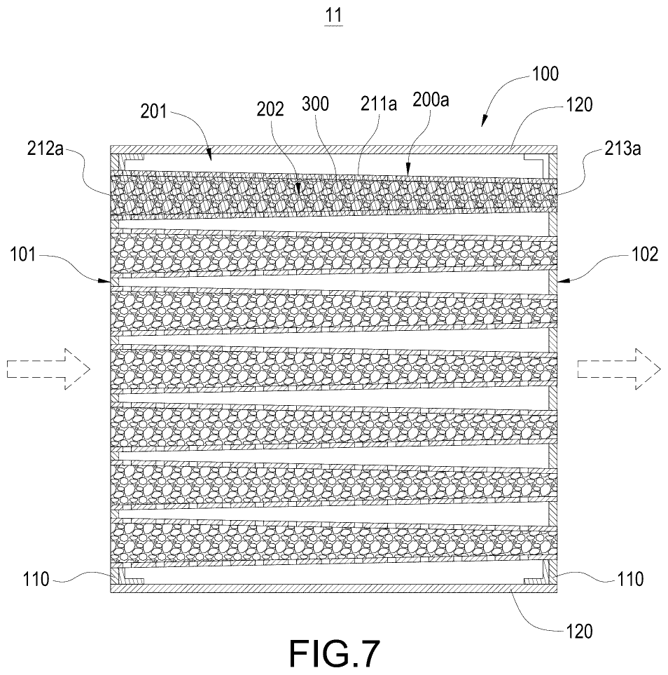

According to the third embodiment of this disclosure as shown in FIG. 7, an adsorption unit 11 having a frame 100, a plurality of spacer tubes 200a and a plurality of adsorption granules 300 is provided.

In this embodiment, the frame 100 has an inlet side 101 and an exhaust side 102. Specifically, the frame 100 has a pair of communicating plates 110 and a plurality of sealing plates 120. The communicating plates 110 are defined with holes so as to be open. The pair of communicating plates 110 are arranged at the inlet side 101 and the exhaust side 102, respectively, so that the inlet side 101 and the exhaust side 102 are open, and the sealing plates 120 are arranged to surround the pair of communication plates 110. The sealing plates 120 are connected between the inlet side 101 and the exhaust side 102 to seal the rest portions of the frame 100.

According to this embodiment, each of spacer tubes 200a is a straight tube made of aluminum or alloy thereof, but the scopes of this disclosure should not be limited to this. Each of the spacer tubes 200a has a lateral side defined with a plurality of through holes 211a to allow air circulation. The spacer tubes 200a are arranged in the frame 100, and the spacer tubes 200a are substantially parallel to each other and separated from each other. Specifically, each of the spacer tubes 200a has two ends connected to the frame 100, respectively, thereby fixing the spacer tubes 200a in the frame 100.

According to this embodiment, each of the spacer tubes 200a has two open ends 212a and 213a opposite to each other, and two of the open ends 212a and 213a on each of the spacer tubes 200 are respectively arranged corresponding to the inlet side 101 and the exhaust side 102. The two open ends 212a and 213a on each of the spacer tubes 200a are connected to the communicating plates 110, respectively, so as to communicate with outside of the frame 100. Each of the spacer tubes 200a is, for example, conical, and on each of the spacer tube 200a, the open end 213a, which is narrower than another open end 213a of the spacer tube 200a, is arranged corresponding to the exhaust side 102. A first space 201 is defined between the frame 100 and the spacer tubes 200, and each of the spacer tubes 200 is defined with a second space 202 therein.

The adsorption granules 300 are granules made of the adsorption material, and the adsorption material is molecular sieve. Each of the adsorption granules 300 is a granule larger than the through hole 211a. Accordingly, the adsorption granules 300 are arranged in the frame 100 and restricted by the spacer tubes 200a to be fixed in the frame 100 between the inlet side 101 and the exhaust side 102. In this embodiment, the adsorption granules 300 are arranged in the second space 202.

Accordingly, air enters the adsorption unit 11 from the environment through the inlet side 101 and is discharged from the adsorption unit 11 through the exhaust side 102 after passing through the flow channel. The ambient air is contacted with the adsorption granules 300 via the through holes 211a when passing through the flow channel, so that carbon dioxide and water carried in the ambient air are adsorbed by the adsorption granules 300. A portion of carbon dioxide and water is removed from the air in the flow channel, and then the air is discharged from the adsorption unit 11 through the exhaust side 102 and returned to the environment.

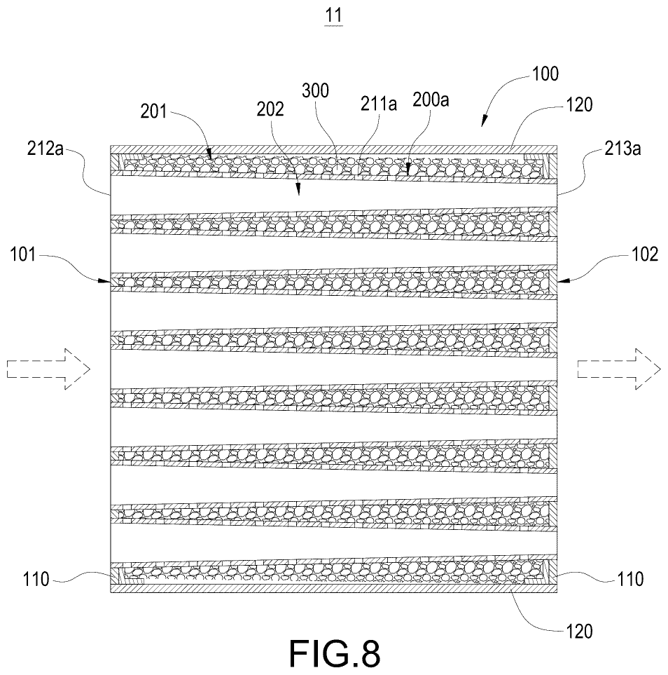

According to the fourth embodiment of this disclosure as shown in FIG. 8, an adsorption unit 11 having a frame 100, a plurality of spacer tubes 200a and a plurality of adsorption granules 300 is provided.

In this embodiment, the frame 100 has an inlet side 101 and an exhaust side 102. Specifically, the frame 100 has a pair of communicating plates 110 and a plurality of sealing plates 120. The communicating plates 110 are defined with holes so as to be open. The pair of communicating plates 110 are arranged at the inlet side 101 and the exhaust side 102, respectively, so that the inlet side 101 and the exhaust side 102 are open, and the sealing plates 120 are arranged to surround the pair of communicating plates 110. The sealing plates 120 are connected between the inlet side 101 and the exhaust side 102 to close the rest portions of the frame 100.

According to this embodiment, each of spacer tubes 200a is a straight tube made of aluminum or alloy thereof, but the scopes of this disclosure should not be limited to this. Each of the spacer tubes 200a has a lateral side defined with a plurality of through holes 211a to allow air circulation. The spacer tubes 200a are arranged in the frame 100, and the spacer tubes 200a are substantially parallel to each other and separated from each other. Specifically, each of the spacer tubes 200a has two ends connected to the frame 100, respectively, thereby fixing the spacer tubes 200a in the frame 100.

According to this embodiment, each of the spacer tubes 200a has two open ends 212a and 213a opposite to each other, and two of the open ends 212a and 213a on each of the spacer tubes 200a are arranged corresponding to the inlet side 101 and the exhaust side 102, respectively. The two open ends 212a and 213a on each of the spacer tubes 200a are connected to the communicating plates 110, respectively, so as to communicate with outside of the frame 100. Each of the spacer tubes 200a is, for example, conical, and on each of the spacer tube 200a, the open end 213a, which is narrower than another open end 213a of the spacer tube 200a, is arranged corresponding to the exhaust side 102. A first space 201 is defined between the frame 100 and the spacer tubes 200a, and each of the spacer tubes 200a is defined with a second space 202 therein.

The adsorption granules 300 are granules made of the adsorption material, and the adsorption material is molecular sieve. Each of the adsorption granules 300 is a granule larger than the through hole 211a. Accordingly, the adsorption granules 300 are arranged in the frame 100 and restricted by the spacer tubes 200a to be fixed in the frame 100 between the inlet side 101 and the exhaust side 102. According to this embodiment, the adsorption granules 300 are disposed in the first space 201, and the second spaces 202 are defined as a flow channel communicated between the inlet side 101 and the exhaust side 102.

Accordingly, air enters the adsorption unit 11 from the environment through the inlet side 101 and is discharged from the adsorption unit 11 through the exhaust side 102 after passing through the flow channel. The ambient air is contacted with the adsorption granules 300 via the through holes 211a when passing through the flow channel, so that carbon dioxide and water carried in the ambient air are adsorbed by the adsorption granules 300. A portion of carbon dioxide and water is removed from the air in the flow channel, and then the air is discharged from the adsorption unit 11 through the exhaust side 102 and returned to the environment.

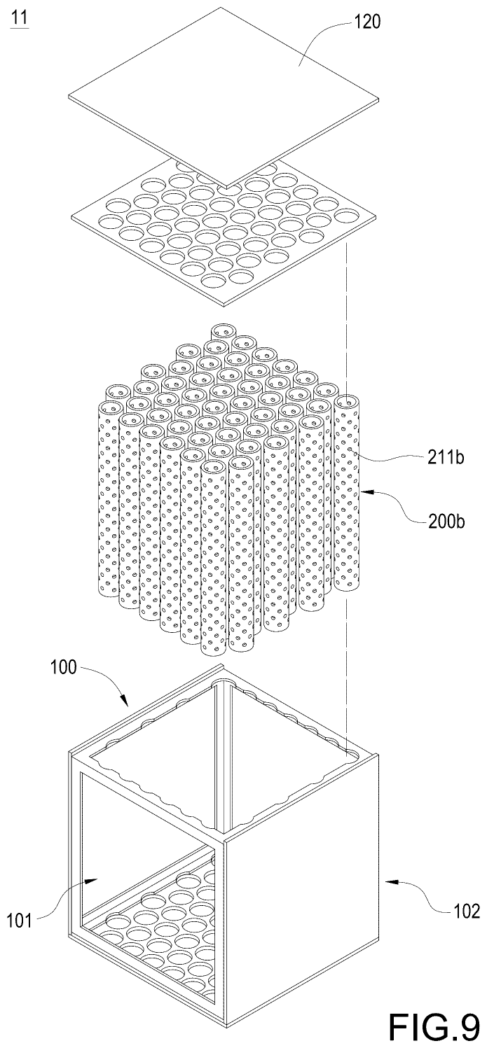

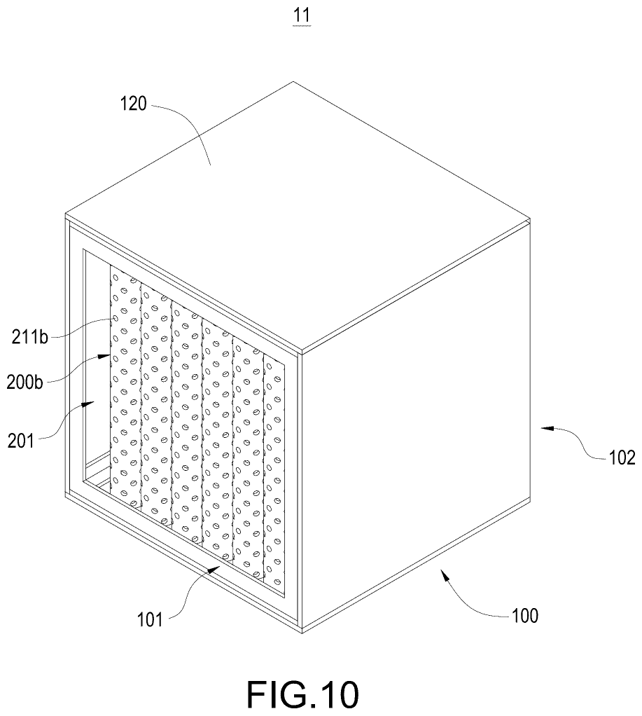

FIG. 9 is an exploded view showing the adsorption unit according to the fifth embodiment of this disclosure, and FIG. 10 is a perspective view showing the adsorption unit according to the fifth embodiment of this disclosure. According to the fifth embodiment of this disclosure as shown in FIGS. 9 and 10, an adsorption unit 11 having a frame 100, a plurality of spacer tubes 200b and a plurality of adsorption granules 300 is provided.

The frame 100 has an inlet side 101 and an exhaust side 102 and has a plurality of sealing plates 120, the inlet side 101 and the exhaust side 102 are open, the sealing plates 120 are annularly arranged and connected between the inlet side 101 and the exhaust side 102 to close the rest portions of the frame 100.

According to this embodiment, each of spacer tubes 200b is a straight tube made of aluminum or alloy thereof, but the scopes of this disclosure should not be limited to this. Each of the spacer tubes 200b has a lateral side defined with a plurality of through holes 211b to allow air circulation. The spacer tubes 200b are arranged in the frame 100, and the spacer tubes 200b are substantially parallel to each other and separated from each other. Each of the spacer tubes 200b is arranged to cross the inlet side 101 and cross the exhaust side 102. Specifically, each of the spacer tubes 200b has two ends connected to the frame 100, respectively, thereby fixing the spacer tubes 200b in the frame 100. A first space 201 is defined between the frame 100 and the spacer tubes 200b, and each of the spacer tubes 200b is defined with a second space 202 therein.

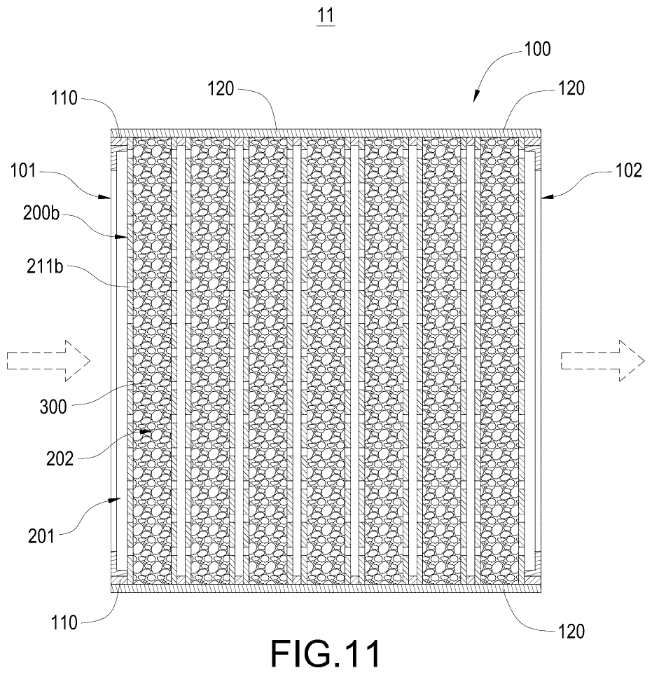

FIG. 11 is a cross-sectional view of the adsorption unit along a passing direction of airflow according to the fifth embodiment of this disclosure. According to FIGS. 10 and 11, the adsorption unit 11 further has a plurality of adsorption granules 300. The adsorption granules 300 are granules made of the adsorption material, and the adsorption material is a molecular sieve. Each of the adsorption granules 300 is a granule larger than the through hole 211b. Accordingly, the adsorption granules 300 are arranged in the frame 100 and restricted by the spacer tubes 200b to be fixed in the frame 100 between the inlet side 101 and the exhaust side 102. In this embodiment, the adsorption granules 300 are arranged in the second space 202. According to this embodiment, the adsorption granules 300 are disposed in the second space 202, and the first space 201 is defined as a flow channel communicated between the inlet sides 101 and the exhaust side 102.

Accordingly, air enters the adsorption unit 11 from the environment through the inlet side 101 and is discharged from the adsorption unit 11 through the exhaust side 102 after passing through the flow channel. The ambient air is contacted with the adsorption granules 300 via the through holes 211b when passing through the flow channel, so that carbon dioxide and water carried in the ambient air are adsorbed by the adsorption granules 300. A portion of carbon dioxide and water is removed from the air in the flow channel, and then the air is discharged from the adsorption unit 11 through the exhaust side 102 and returned to the environment.

According to this disclosure, the adsorption unit adsorption unit has a frame for limiting a flow direction of the airflow, and the adsorption unit further has spacer tubes arranged in the frame. The adsorption granules are arranged along the flow direction of the airflow via the spacer tubes so that the air is contacted with the adsorption granules in a longer period when passing through the adsorption unit, and carbon dioxide and water are therefore adsorbed from the air more efficiently by the adsorption granules.

While this disclosure has been described by means of specific embodiments, numerous modifications and variations could be made thereto by those skilled in the art without departing from the scope and spirit of this disclosure set forth in the claims.

What is claimed is:

1. An adsorption unit, comprising:
a frame, comprising an inlet side and an exhaust side;
a plurality of spacer tubes, arranged in the frame, each of the spacer tubes comprising a lateral side defined with a plurality of through holes; and
a plurality of adsorption granules, arranged in the frame, and the adsorption granules being restricted by the spacer tubes to be fixed in the frame and between the inlet side and the exhaust side.

2. The adsorption unit according to claim 1, wherein a first space is defined between the frame and the spacer tubes, and the adsorption granules are disposed in the first space.

3. The adsorption unit according to claim 1, wherein each of the spacer tubes comprises a second space defined therein, and the adsorption granules are disposed in the second spaces.

4. The adsorption unit according to claim 3, wherein the frame comprises a plurality of sealing plates, the sealing plates are annularly arranged to connect between the inlet side and the exhaust side, and each of the spacer tubes is arranged to cross the inlet side and cross the exhaust side.

5. The adsorption unit according to claim 1, wherein each of the spacer tubes comprises two open ends opposite to each other, and two of the open ends on each of the spacer tubes are arranged corresponding to the inlet side and the exhaust side, respectively.

6. The adsorption unit according to claim 5, wherein the frame comprises a pair of communicating plates and a plurality of sealing plates, the pair of communicating plates are arranged at the inlet side and the exhaust side, respectively, the sealing plates are arranged to surround the pair of communicating plates and connected between the pair of communicating plates, and each of the open ends on each of the spacer tubes is connected to the communicating plates to communicate with outside of the frame.

7. The adsorption unit according to claim 5, wherein each of the spacer tubes is conical, and on each of the spacer tube, a narrower one of the open ends of the spacer tube is arranged corresponding to the exhaust side.

8. The adsorption unit according to claim 1, wherein the spacer tubes are fixed in the frame, each of the spacer tube comprises two ends connected to the frame, respectively.

9. The adsorption unit according to claim 1, wherein the spacer tubes are substantially parallel to each other and separated from each other.

10. The adsorption unit according to claim 1, wherein each of the spacer tubes is made of aluminum or alloy thereof.
